(19) United States
(12) Patent Application Publication
(10) Pub. No.: US 2003/0054837 A1
(43) Pub. Date: Mar. 20, 2003

(54) Telephone call routing system and method

(76) Inventor: Mark Kieran Ennis, London (GB)

Correspondence Address: Miller, Canfield, Paddock and Stone P.L.C., c/o Robert Kelley Roth, Suite 2500, 150 West Jefferson Ave., Detroit, MI, 48226, US

(21) Appl. No.: 10/178,652

(22) Filed: Jun. 24, 2002

(30) Foreign Application Priority Data
Sep. 17, 2001 (GB) 01123498.1
Jun. 19, 2002 (GB) 0214152.1

(51) Int. Cl. H04Q 7/20

(52) U.S. Cl. 455/456; 455/445

(57) ABSTRACT

A telephone call routing system routes a telephone call from a caller to a mobile resource which is local to the caller and available. Specifically, the mobile resource may be a taxi, such that a customer can “hail” a taxi, without being in the direct line of sight of a taxi driver. An automatic coordinator manages the mobile resources and callers to a call centre and can automatically allocate available and nearby mobile resources to a caller, so that conversation between the caller and an operator of the mobile resource helps direct the mobile resource to the caller.

### RELATED APPLICATION

This application claims priority benefit of U.K. provisional patent application No. 01123498.1 filed on Sep. 17, 2001 and U.K. patent application No. GB 0214152.1 filed on Jun. 19, 2002.

### FIELD OF THE INVENTION

This invention relates to a telephone call routing system and, more particularly, to a telephone call routing system for connecting a telephone call from a caller to a mobile resource.

### BACKGROUND OF THE INVENTION

The present invention relates to a telephone call routing system for routing a telephone call from a caller to one or more mobile resources where a mobile resource is defined as any resource which is not confined to a specific location and which, due to the nature of its work, may often move from one location to another without returning to a specific central location. Some examples of such mobile resources are taxis, repair vehicles, police vehicles, doctors on-call, ambulances and utility service vehicles. More specifically, this invention relates to a system and method of routing a telephone call from a caller to a nearby mobile resource, so that the caller and operator of the mobile resource can engage in conversation for exchanging information, such as directions to each other's current location or a meeting time. It is proposed that such a system be known as “Zingo”, for which there is presently a pending European Community Trade Mark Application.

At the present time, when a caller wishes to contact a mobile resource to arrange a pickup or meeting, it is required that they telephone a call centre and speak to a call centre operator, who will record the caller's details, such as name, location and telephone number and then make a second call to an operator of a mobile resource to pass these details on. The call centre operator chooses the mobile resource which the call centre operator considers to be available and close to the caller. An example is a caller booking a taxi, in which the caller telephones a call centre to give the call centre operator their name and location. This information is passed on to taxi drivers by radio, data messages or a mobile telephone call. The taxi drivers then “bid” for the booking, depending on their current availability and location relative to the caller. A further example is a caller requiring automobile breakdown assistance, in which the caller telephones a call centre and gives the call centre operator their name, location and breakdown problem. The call centre operator then passes this information to a breakdown engineer, who is generally remote from the call centre, but considered to be near the caller and available.

One problem with present systems and methods is that there is limited interaction between the caller and the mobile resource operator. The caller's details are passed to the mobile resource operator by the call centre operator, who may not know the exact availability of the mobile resource, the exact location of either the caller or the mobile resource, or other information, such as the amount of traffic or the presence of one-way streets on route to the caller. Furthermore, at some stage in the passing of the caller's details to the mobile resource operator, there is the opportunity for incorrect information to be passed.

A further problem associated with present systems and methods is the high cost of the infrastructure. The cost of a call centre, employing many operators, can form a considerable proportion of an organisation's overhead. This cost is likely to be passed on to both callers and mobile resource operators. For example, in the case of a caller ordering a taxi, a booking fee may form a significant proportion of the overall cost to the caller, whilst the taxi driver may also be subscribing to the syndicate or company providing the call centre. Furthermore, there are other associated high costs relating to the equipment which may have to be employed to pass information between the call centre operator and the mobile resource operator. For example there are several London based taxi booking and allocation services, which transfer information, such as directions to the caller, taxi availability and acceptance or rejection of jobs, between a call centre and taxi drivers. Such services require complex and expensive terminals to be fitted into subscribing taxis.

Yet a further problem associated with present systems and methods, particularly in relation to taxi drivers, is the amount of time spent looking for work. For example, in London, currently up to forty percent of a taxi driver's time is spent searching for work. Often, there may be a potential customer in the vicinity of the taxi, but many potential jobs go unnoticed because there is currently no method for “hailing” a taxi without direct line of sight between the taxi driver and customer.

There are a number of technologies for locating the position of a mobile resource. Among these, the Global Positioning System (GPS) is well known in the art. The difference in time of arrival at a ground based receiver of signals arriving from a number of satellites orbiting the Earth can be used to locate the position of the receiver to within ten metres. The accuracy of the position depends on the quality of the signal, which may vary due to environmental conditions, such as the presence of tall buildings or bad weather.

The existing infra-structure of mobile telephone networks can allow a call centre to determine the approximate location of callers on mobile telephones. One such method uses a Cell of Origin (COO) technique to give an approximate location for a mobile terminal by examining which cell of a mobile network the mobile device is currently registered to. Another mobile telephone network location positioning system relies on a Time of Arrival (TOA) technique, which determines the location of the mobile terminal by calculating the difference in the time of arrival of a signal from the mobile terminal at at least 3 base stations. Yet another mobile telephone location system, described in WO 97/11384, uses an Enhanced Observed Time Difference Method (E-OTD) to locate the position of a mobile terminal by using fixed Location Measurement Units (LMU) overlaid on the mobile network to act as reference beacons for determining the mobile terminal's location.

Mobile telephone location systems, as described above, are used by mobile telephone network operators to maintain mobile telephone location databases, which store the location of mobile telephones on their networks. The location databases can be accessed remotely by third parties who are able to perform a reverse-lookup of the telephone number of the caller's mobile phone, obtained using Caller Line Identification (CLI), to obtain an approximate grid reference for the location of the mobile telephone.

The location of a caller making a telephone call from a fixed line telephone can be determined by performing a reverse-lookup on a central directory of fixed line telephone numbers, to obtain a grid reference for the caller. In the United Kingdom, this database is known as OSIS and is provided by British Telecommunications Plc.

Automated call centres for handling telephone calls, without the presence of an operator, are already known in the state of the art. The call centre may use a Computer Telephony Integration (CTI) system, which can automatically route telephone calls to appropriate devices or persons. An Interactive Voice Response (UVR) server may be used to interpret touch-tones from the caller's handset to allow interaction with a database.

Computer Telephony Integration (CTI) and caller location systems which automatically provide callers with contact information for nearby fixed resources are already known in the art. In one such system, known as FindMe®, provided by the UK mobile telephone network operator, mmO₂, a caller dials into an IVR server to receive contact information for nearby selected resources by Short Message Service (SMS) on their mobile telephone. The call centre determines the location of the caller by performing a reverse-lookup of the caller's mobile telephone number on mmO₂'s database of mobile telephone locations, obtained by using COO techniques. In such a system, the resources are at fixed locations. [I feel this needs to be more clearly distinguished from the invention, as by listing a negative limitation of CTI if it would be applied to ZINGO like applications.]

Therefore, what is required is a solution to the frustrating problem of contacting a local mobile resource, which is available, but may not be in the direct line of sight of a potential customer.

### SUMMARY OF THE INVENTION

In accordance a first aspect, there is provided a telephone call routing system comprising, caller location means adapted to produce a caller location signal corresponding to a location of a caller making a telephone call, mobile resource location means adapted to produce a resource location signal corresponding to a location of at least one mobile resource, and a coordinator which can receive and process the caller location signal and the resource location signal, and route the telephone call to the mobile resource most conveniently proximate to the caller.

In accordance with another aspect, a method for routing a telephone call from a caller to one or more mobile resources, comprising the steps of determining the location of the caller, determining the location of at least one mobile resource, and routing the telephone call from the caller to the mobile resource conveniently proximate the caller.

In accordance with another aspect, a method for selecting a mobile resource having a first known location with respect to a caller having a second known location, comprises the steps of determining an uncertainty circle corresponding to the location of at least one mobile resources, selecting a group of available mobile resources having circles of uncertainty which lie entirely within a predetermined distance from the caller, and selecting the mobile resource having the circle of uncertainty with a centre closest to the caller from the group of available mobile resources.

From the foregoing disclosure and the following more detailed description of various preferred embodiments it will be apparent to those skilled in the art that the present invention provides a significant advance in the technology and art of telephone call routing systems and methods. Particularly significant in this regard is the potential the invention affords for providing a high quality telephone call routing system of reduced cost for mobile resources such as taxis. Additional features and advantages of various preferred embodiments will be better understood in view of the detailed description provided below.

### BRIEF DESCRIPTION OF THE DRAWINGS

FIG. 1 is an overview of the telephone call routing system in accordance with a preferred embodiment of the present invention.

FIG. 2 is a diagram showing the caller connecting to the call centre on a mobile telephone.

FIG. 3 is a diagram showing the caller connecting to the call centre on a fixed line telephone.

FIG. 4 is an diagram of a taxi being used as a mobile resource according to the present invention.

FIG. 5 is diagram of the call centre according to the present invention.

FIG. 6 is a diagram illustrating how the taxi terminal updates the call centre with the location of the taxi.

FIG. 7 is a diagram illustrating how a nearby taxi is selected.

It should be understood that the appended drawings are not necessarily to scale, presenting a somewhat simplified representation of various preferred features illustrative of the basic principles of the invention. The specific design features of the telephone call routing system as disclosed here, including, for example, the specific software used by the coordinator, will be determined in part by the particular intended application and use environment. Certain features of the illustrated embodiments have been enlarged or distorted relative to others to enhance visualisation and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the telephone call routing system disclosed here. The following detailed discussion of various alternative and preferred features and embodiments will illustrate the general principles of the invention with reference to a telephone call routing system for use with a taxi. Other embodiments suitable for other applications will be apparent to those skilled in the art given the benefit of this disclosure.

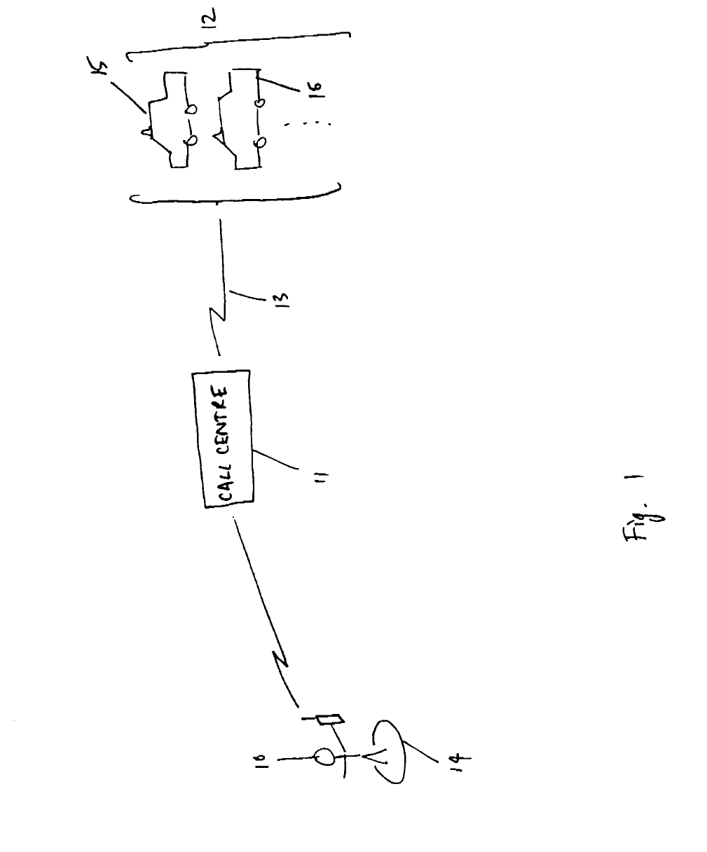

Referring now to the drawings, FIG. 1 illustrates a caller (10) who telephones a call centre (11) to hail a taxi from a group of taxis (12). The taxis (12) transmit, at varying intervals, updates of their location, speed, heading and availability across the wireless data link (13) to the call centre (11). The call centre (11) determines a location (14) for the caller (10) and establishes which taxis (12) are nearby. The call centre (11) then selects a nearby available taxi (15) and routes the telephone call to a mobile telephone in the nearby available taxi (15). By nearby, it will be readily understood that this means that the taxi is conveniently proximate to the caller. Ordinarily this would be the taxi which is geographically closest to the caller. However, the call centre may use an algorithm which takes into account which streets are one-way or difficult to access due to construction or time of day traffic, and/or caller preference for a particular taxi or taxi driver, etc., and route the call to a more convenient taxi. If the mobile telephone in the taxi (15) is unavailable, for example if it is engaged or out of service, then the call centre (11) routes the call to another nearby available taxi (16). The caller can then speak directly with a driver of the taxi (16) to pass their location (14) for pickup or, at the taxi driver's request, move to a more convenient pickup point.

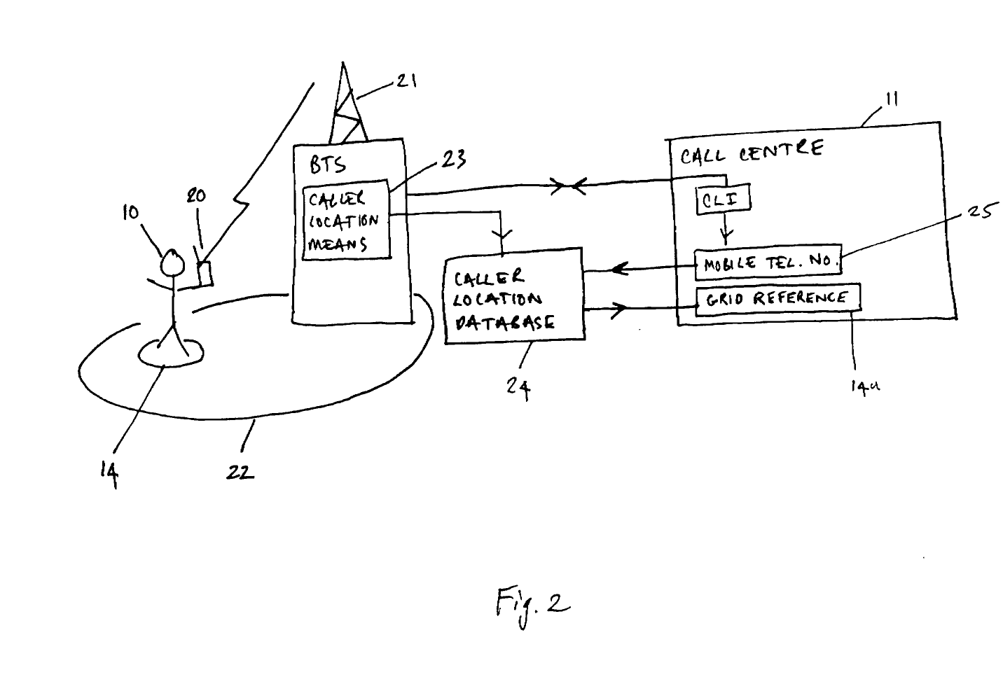

Referring to FIG. 2, the caller (10) is shown using a mobile telephone (20) to hail the taxi from the group of taxis (12). The mobile telephone (20) is registered to a mobile telephone base station (BTS) (21) in a cell (22). Caller location means (23) determines a location (14) of the caller using COO (Cell of Origin), TOA (Time of Arrival) or E-TOA (Enhanced Time of Arrival) techniques. The location (14) of the caller is periodically updated in a caller location database (24). The caller (10) makes a telephone call to the call centre (11), which determines the mobile telephone number of the caller using Caller Line identification (CLI) and looks up the location (14) of the caller by passing the mobile telephone number (25) to the caller location database (24). The location (14) of the caller is returned to the call centre (11) as a longitude/latitude and a radius of uncertainty.

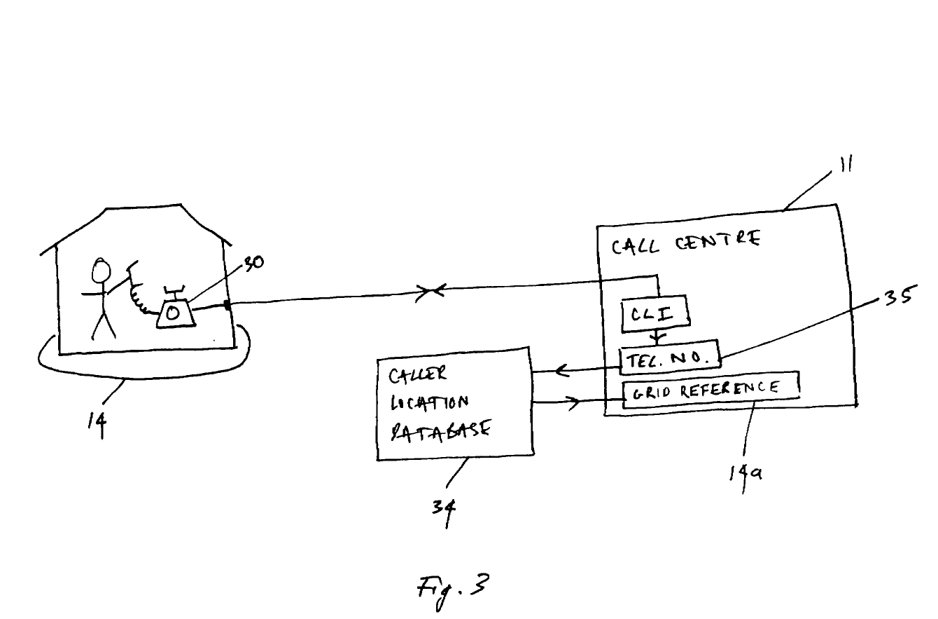

Referring to FIG. 3, the caller (10) is shown using a fixed line telephone (30) to hail a taxi from a group of taxis (12). The location (14) of a caller's fixed line telephone (30) is stored in a caller location database (34) for future reference. The caller (10) places a telephone call to the call centre (11), which determines the fixed line telephone number of the caller using Caller Line Identification (CLI) and looks up the location (14) of the caller by passing the fixed line telephone number (35) to the caller location database (34). The location (14) of the caller is returned as a grid reference (14a).

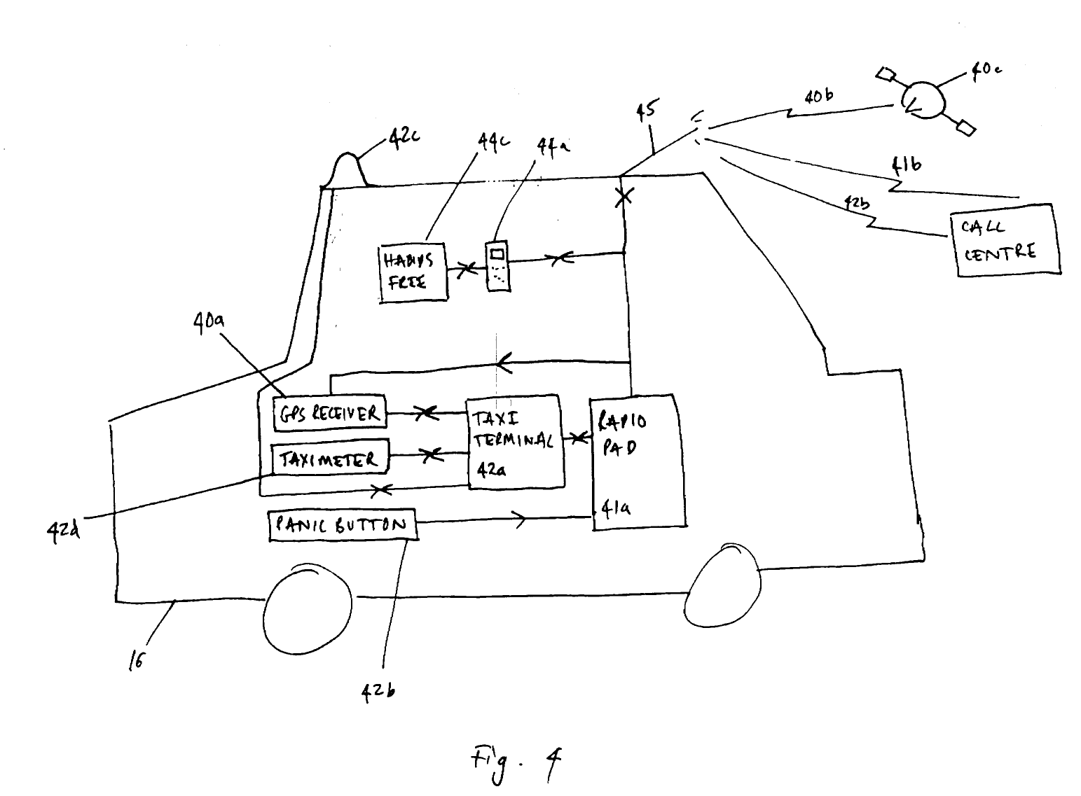

Referring to FIG. 4, a GPS (Global Positioning System) receiver (40a) in the taxi (16) determines a location, speed and heading for the taxi (16) by receiving GPS signals (40b) through a multi-functional antenna (45) from satellites (40c). A taxi terminal (42a) monitors and controls the GPS receiver (40a) and passes, at varying intervals, samples of the location, speed and heading of the taxi to a radio-pad (41 a), which also receives data from a taxi panic button (42b). The taxi terminal (42a) also monitors the availability of the taxi (16) from a taxi hire sign (42c) and/or a taxi meter (42d). The location, speed, heading and availability of the taxi is transmitted by taxi terminal (42a) from the radio-pad (41 a) over a wireless data link (41b) through the multi-functional antenna (45). Additionally, the taxi terminal (42a) may process credit and debit card payments by transmitting and receiving payment transaction data across the wireless data link (41b).

The wireless data link (41b) may use an X25 packet radio network. Other implementations may use General Packet Radio Service (GPRS), Universal Mobile Telecommunications Service (UMTS), Cellular Digital Packet Data (CDPD) or Short Message Service (SMS) based services (see glossary). The taxi (16) is also fitted with a mobile telephone (44a) and an associated hands-free kit (44c), which may also transmit and receive mobile telephone data signals (42b) through the multi-functional antenna (45). The GPS receiver (40a) may be built into the radio-pad (41a). The taxi terminal (42a) and the GPS receiver (40a) may also receive other data, such as charging rates for the taxi meter and region parameter data from the call centre (11) across the wireless data link (41b).

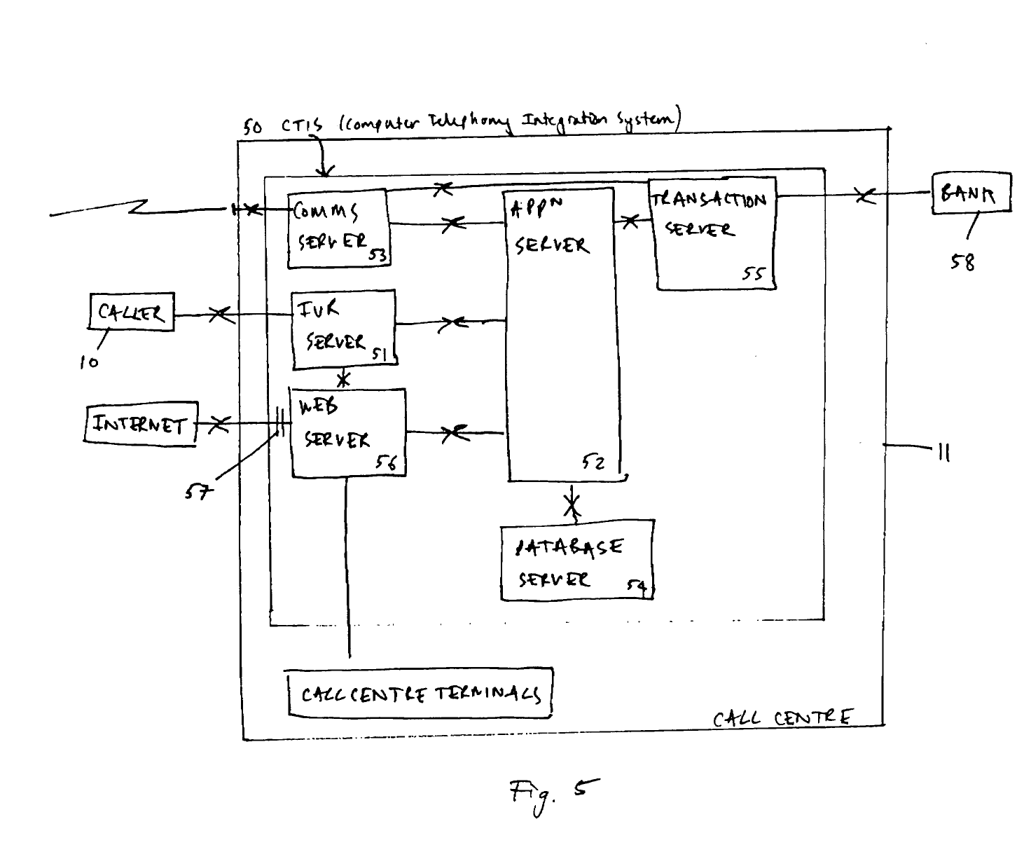

Referring to FIG. 5, a computer telephony integration system (50), acting as a coordinator, is the key to the call centre (11) and includes an interactive voice response (IVR) server (51), an application server (52), a communication server (53), a database server (54) and a transaction server (55). There may also be a web server (56), connected externally to the Internet through a firewall and intrusion detection system (57). An incoming telephone call from a caller (10) arrives at the interactive voice response (IVR) server (51), which determines the telephone number of the caller and may respond with an appropriate welcoming message. The interactive voice response (IVR) server may also check whether the telephone number of the incoming telephone call is on a barred phone list and can select a dedicated account for the caller using the telephone number of the caller (10) or an account number entered by the caller (10).

The application server (52) interprets, administers and responds to requests from the interactive voice response server (51). On receipt of an instruction from the interactive voice response server to locate the caller (10), the application server (51) checks whether the telephone call originates from a mobile or fixed line telephone. If the telephone call originates from a mobile telephone, the mobile telephone network operator is determined. Depending on whether the telephone call originates from a mobile or a fixed line telephone, the telephone number is passed to an external mobile telephone database (24) or fixed line caller location database (34) to perform a reverse lookup of the location (14) of the caller.

The application server (52) also interprets and administers messages from the taxis (12), including storing location updates and availability and predicting locations for the taxis (12). The application server (52) may also log taxi drivers, vehicles and other equipment in and out of the system, as well as alert a call centre operative if a taxi panic button (42b) is pressed and bar equipment from being used if a taxi or other equipment is stolen. Other functions of the application server (52) may include managing caller, taxi driver and/or corporate information, registering new taxi drivers, handling complaints and feedback and administering operations team applications, such as the quality of service, system degradation, call centre systems resources and expansion and equipment installation and misuse.

Furthermore, the application server (52) may allow individual callers (10) to connect with preferred taxi drivers. The interactive voice response server (51) can recognise a caller (10), either from the telephone number of the caller or an account number, entered by the caller (10). Additionally, individual taxi drivers may allocate a group of preferred colleagues to their customers, such that if a caller's preferred taxi driver is busy, then the caller's telephone call is routed to another nearby taxi driver, which has been recommended by the caller's normal taxi driver.

The communications server (53) receives data from the taxis (12) across the wireless data link (41b) and decodes the data into messages. If the message is payment transaction data, then it is sent to the transaction server (55). If the message is a taxi location update, then it is sent to the application server (52).

The web server (56) acts as a user interface for the interactive voice response (IVR) server (51) and the application server (52). Access to the web server (56) can either be internal to the call centre by call centre operatives or be remote to the call centre across the Internet through a firewall and intrusion detection system (57) by customers or taxi drivers.

The transaction server (55) receives payment transaction data from the communications server (53) and connects to an acquiring bank (58) when authorisation is required. Payment transaction confirmation messages are then passed back to the communications server for transmitting to a taxi (16) or handling by the application server (52). Credit or debit card transactions may be received on the taxi terminal and transmitted to transaction server (55) via the communications server (53) across the wireless data link (41b). The transaction server connects to the acquiring bank when authorisation is required under the agreed terms. The transaction method may be APACS29 or APACS30 (see glossary).

The database server (54) passes stored data to and from the application server (52), and manages data access, as well as data recovery in the case of failure.

Other business processes, such as billing and account management, may take place remote from the call centre (11), such that data from the database server (54) can be accessed and processed offline. The entire computer telephony integration system (50) may be housed remote from the call centre (11) in a secure, dedicated location, where servers may be pre-conFig.d with Internet connections and also include regulated power, security and support. Call centre operatives, managers, taxi drivers and customers may then access the computer telephony integration system through a web browser across the Internet.

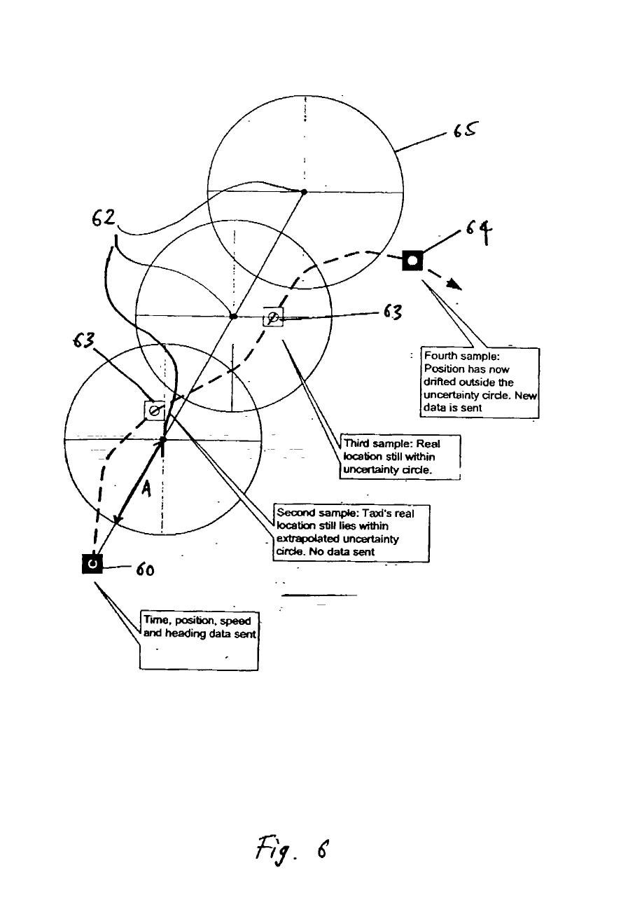

Referring to FIG. 6, the taxi terminal (42a) nominally reads data from the GPS receiver (40a) once per second and averages the readings to produce a first sample (60) comprising the time of day and the location, speed and heading of the taxi. The first sample (60) is transmitted to the call centre (11). Both the taxi terminal (42a) and the application server (52) in the call centre (11) extrapolate predicted locations (62) for the taxi at anytime after transmission of the first sample (60). Further samples (63) are produced by the taxi terminal (42a) and a second sample (64) is only sent to the call centre (11) if the location of the taxi has moved outside an uncertainty circle (65), surrounding the predicted locations (62) and defined by a distance (A). The uncertainty circle (65) is therefore related to the frequency of transmission of data from the GPS receiver (40a).

The taxi terminal (42a) and the application server (52) extrapolate predicted locations (62) for the taxis by considering the last sample transmitted from the taxi terminal (42a) or last sample received at the call centre (11). By taking account of the location, speed and heading of the taxi, as given in the sample, a predicted location can be calculated at both the taxi (16) and the call centre (11). The call centre (11) uses predicted locations and specified uncertainty circles (65) for each of the taxis (12) as the basis for selecting a nearby taxi (16) for a caller. The taxi (16) uses the predicted locations and associated uncertainty circles (65) to decide when to send a new sample of the “real” location, speed and heading of the taxi to the call centre (11). Therefore, for accurate position tracking of the taxis (12), excessive, and therefore costly, transmissions do not need to be sent continuously.

The distance (A), can be updated over the wireless data link (41b) from the call centre (11), depending on the location of the taxi and time of day. Thus, the call centre has control over how often data is transmitted across the wireless data link (41b). The distance (A) is defined for a particular parameter region at a particular time of day and can be changed, for example, if the time of day is rush hour or if the taxi is in an urban area. Other parameter region data which can be changed and sent to the taxi terminal (42a) from the call centre (11), depending on the location of the taxi and time of day, may include: the number of readings taken to form a sample, the interval between taking readings from the GPS receiver (40a), and absolute minimum and maximum update intervals. The latter two parameters override the conditional transmission of data to the call centre (11), so that data transmission either does not occur too often or does not occur at all, for example when the taxi is out of range for using the wireless data link (41b).

The speed of the taxi (16) has an effect on the transmission rate to the call centre (11). A parked and unavailable taxi may not need to send any updates. However, as soon as a taxi (16) becomes available, an update should be sent immediately. Stationary or slow moving taxis are likely to send infrequent updates. A normal speed taxi, which may be defined as moving at between 12.8 and 20.8 km/hr, sends the highest number of updates, compared to taxis which may be moving at high speed, defined as moving greater than 30.4 km/hr. For different ranges of speed, there may be different methods for predicting the location of taxis, both at the taxi terminal (42a) and at the application server (52), as well as different methods for selecting a taxi (16) for allocation to a caller (10). As an example, the frequency or interval of transmission of location updates to the call centre (11), may be up to twice per minute.

The database server (54) may store parameter region data for different regions for different times of the day, thereby allowing optimal location tracking from the taxi terminal (42a). As the taxi (16) moves from one region to another at a given time of day, the parameter region data can be changed by updating the taxi terminal (42a) from the call centre (11) across the wireless data link (41b). If there is no parameter region data stored for a given region and time of day, then the taxi terminal (42a) may continue to use the previously received parameter region data.

The application server (52) may also analyse the samples received from the taxi terminals (42a) and determine the traffic density surrounding the taxis (12), so that, when selecting a given taxi (16) for a particular caller (10), intelligent automatic allocation may be performed. This way, taxis which may be close to a given caller (10), but which are in heavy traffic, are not allocated. Instead, a taxi moving freely, but, which is further away from the caller, (10) may be selected.

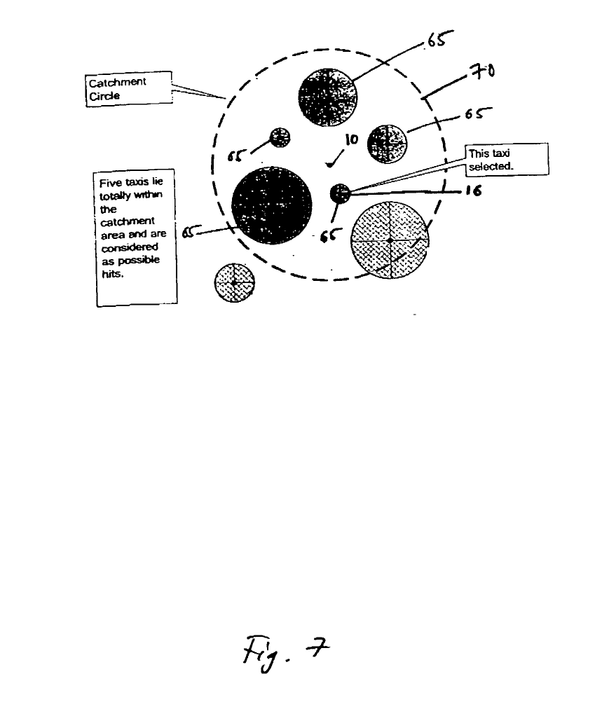

Referring to FIG. 7, the application server (52) selects a nearby taxi (16) to route a telephone call to by defining a catchment area (70) around the caller (10). A nearby taxi (16) is selected from a group of available taxis having uncertainty circles (65) and contained entirely within the catchment area (70).

In accordance with a highly advantageous feature, the taxi (16) having its centre of uncertainty circle (70) closest to the caller (10) is selected. In other preferred embodiments, a taxi, which has its centre of uncertainty circle (70) further away from the caller (10) than other taxis in the catchment area (70), may be selected by considering the size of some or all of the uncertainty circles of the taxis in the catchment area (70), the direction of travel of the taxis in the catchment area (70) and the expected locations of the taxis (70).

To increase the chance that a selected taxi (16) is within a certain distance and hence reduce wait time of the caller (10), the size of the catchment circle (70) can be reduced, particularly if the location (14) of the caller becomes known with less accuracy. The size of the catchment circle (70) may be a parameter which can be varied depending on the location of the caller (14) and may be stored for different administrative regions.

Glossary of Terms

Association for Payment Clearing Services (APACS)

APACS29 or APACS30 is a payment transaction method for transmitting credit and debit card transactions to acquiring banks. “29” is a standard developed to settle credit card payments as a batch process, usually overnight. “30” is the specification for a credit authorisation terminal to enable online (directly with the bank) secure authorisation of payment transactions. Once authorised the payment is guaranteed providing you have the card, cardholder present, and a signature from the cardholder during authorisation.

Cell of Origin (COO)

Cell of Origin (COO) identifies which cell a caller is in and looks up the location of the cell centroid in a geographical database. COO is a variable and not a very precise locator. Depending on the number of base stations in the search area, accuracy may be within one hundred meters of the target in an urban area or as far off as thirty kilometers away from the target where base stations are less densely concentrated.

Cellular Digital Packet Data (CDPD)

CPD is and analogue cellular packet data system, which is widely deployed across the USA. It may form the backbone for data communication, in the absence of a GPRS system, in the USA.

Computer Telephony Integration (CTI)

Computer Telephony Integration (CTI) refers to systems that enable a computer to act as a call center, accepting incoming calls and routing them to the appropriate device or person. The systems can handle all sorts of incoming and outgoing communications, including phone calls, faxes, and internet messages. Some of them also have the ability to authenticate callers, recognize voices, receive faxes and route them to the appropriate fax machines, and match the caller's number with their customer record and display it for reference.

Enhanced-Observed Time of Difference (E-OTD)

Enhanced Observed Time Difference (E-OTD) systems operate using reference beacons and Location Measurement Units (LMUs) overlaid on the cellular network. Each beacon has an accurate timing source and when a signal from at least three beacons is received by a mobile running E-OTD software and also by an LMU, the time differences of arrival of the signal from each beacon at the handset and at the Location Measurement Unit are calculated. The differences in time stamps are then combined to estimate the location of the handset.

E-OTD schemes offer greater positioning accuracy than cell of origin, between 50 and 125 metres, but have a slower speed of response, typically around five seconds, and require software modified handsets, which means that they cannot be used to provide location specific services to existing customer bases.

General Packet Radio Service (GPRS)

General Packet Radio Service (GPRS) is a packet-based wireless communication service that promises data rates from 56 up to 114 Kbps and continuous connection to the Internet for mobile phone and computer users. GPRS is based on Global System for Mobile (GSM) communication and is seen as a “2.5G” technology, being a stepping-stone from second generation GSM to third generation UMTS.

In theory, a GPRS based service should cost users less than circuit-switched services since communication channels are being used on a shared-use, as-packets-are-needed basis rather than dedicated only to one user at a time. Indicative costs from Vodafone are £1/megabyte, which is an order of magnitude less than PRS. GPRS may eventually enable the present invention to operate across Europe (where there is no PRS coverage) and to generate floating car data (at affordable transmission cost).

Global Positioning System (GPS)

Global Positioning System (GPS) is a system of 24 satellites. By triangulation of signals from four of the satellites, a receiving unit can pinpoint its current location anywhere on earth to within a few meters. Speed and direction of motion can also be calculated directly from the GPS signal. However, the signal from the satellites is extremely weak and the need for direct line of sight to at least 4 satellites means that GPS systems can suffer from an “urban canyon” problem whereby they are unable to get a good fix under trees or close to tall buildings.

Interactive Voice Response (IVR)

Interactive Voice Response (IVR) is a software application in which a touch-tone telephone is used to interact with a database (pre recorded voice responses), to either acquire information from or enter data into it. IVR technology does not require human interaction over the telephone as the user's interaction with the database is predetermined by what the IVR system will allow the user access to.

Mobile Telephone Generations (2, 2.5 and 3G)

The first generation of phones were analogue. In Europe, current digital phones are thought of as “second generation”, or “2G”. General Packet Radio Service (GPRS) and High Speed Circuit Switched Data (HSCD) are considered “2.5G”, while “3G”, also known as Universal Mobile Telephone Service (UMTS) is the forthcoming system using Code Division Multiple Access (CDMA) modulation.

Packet Radio Service (PRS)

PRS is a virtual X25 data network operated by Vodafone in the UK (only). The system is cell-based the cells being somewhat larger than GSM cells (due to the lower frequency of the signal). Radio pads (PRS data modems) can operate in fixed, portable and mobile modes, although calls in progress cannot be handed from one cell to another. PRS operates at 4800 bps, which is about half the rate of a fax machine or standard GSM data call.

Short Message Service (SMS)

Short Message Service (SMS) is a service for sending messages of up to 160 alphanumeric characters to mobile phones that use the GSM network, much like a pager system. However, SMS messages do not require the mobile phone to be active and within range, as the message will be held for a number of days until the phone is available.

Time of arrival (TOA)

The difference in time of arrival of a signal from a mobile device at three base stations is used to calculate location. In this scheme, however, there may be no overlay network used as the Location Measurement Unit (LMU). Instead, this functionality is provided by synchronization of the cellular network, using GPS at each base station.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A telephone call routing system comprising, in combination:
caller location means adapted to produce a caller location signal corresponding to a location of a caller making a telephone call;
mobile resource location means adapted to produce a resource location signal corresponding to a location of at least one mobile resource; and
a coordinator which can receive and process the caller location signal and the resource location signal, and route the telephone call to the mobile resource most conveniently proximate to the caller.

2. The telephone call routing system of claim 1, wherein the coordinator routes the telephone call to a mobile telephone located in the mobile resource.

3. The telephone call routing system of claim 1, wherein the mobile resource is a vehicle, such that the telephone call between the caller and a mobile resource operator facilitates a meeting of the mobile resource and the caller.

4. The telephone call routing system of claim 3, wherein the vehicle is a taxi and the mobile resource operator is a taxi driver.

5. The telephone call routing system of claim 1 wherein the resource location signal is transmitted to the coordinator across a wireless data link.

6. The telephone call routing system of claim 1 further comprising a status monitor to determine an availability of the mobile resource.

7. The telephone call routing system of claim 6, wherein the status monitor transmits the availability of the mobile resource to the coordinator across a wireless data link, such that the coordinator can route the telephone call to a mobile phone in the conveniently proximate mobile resource.

8. The telephone call routing system of claim 1, wherein the mobile resource comprises a payment terminal which transmits payment transaction data to the coordinator across a wireless data link.

9. The telephone call routing system of claim 8, wherein the mobile resource location means is contained in the payment terminal.

10. The telephone call routing system of claim 1, wherein a signal can be transmitted from the coordinator to the mobile resource across a wireless data link.

11. The telephone call routing system of claim 1, wherein the mobile resource location means comprises a Global Positioning System (GPS) receiver.

12. The telephone call routing system of claim 11, wherein the mobile resource comprises a multifunctional antenna for receiving and transmitting data across a wireless data link, receiving and transmitting mobile telephone signals from a mobile telephone and receiving GPS signals.

13. The telephone call routing system claim 1, wherein the telephone call originates from a mobile telephone.

14. The telephone call routing system claim 13, wherein the caller location means determines the location of the caller using a cell of origin of the mobile telephone.

15. The telephone call routing system of claim 13, wherein the caller location means determines the location of the caller by calculating a difference in time of arrival of a mobile telephone signal from the mobile telephone to at least three base stations whose locations are known.

16. The telephone call routing system of claim 13, wherein the caller location means determines a location for the caller by calculating a difference in times of arrival at the mobile telephone and at additional receivers, whose locations are known, of signals from at least three base stations.

17. The telephone call routing system of claim 1 wherein the telephone call originates from a fixed line telephone.

18. The telephone call routing system of claim 17, wherein the caller location means determines the location of the caller by looking up a location of the fixed line telephone using a fixed line telephone number.

19. The telephone call routing system of claim 1, wherein the coordinator comprises an interactive voice response server to allow the caller to interact with the coordinator and to route telephone calls from the caller to a mobile resource.

20. The telephone call routing system of claim 1 wherein the coordinator comprises a communications server which can receive the resource location signal of one or more mobile resources and can transmit a data signal.

21. The telephone call routing system of claim 20, wherein the coordinator comprises an application server for interpreting the data signal received from the communications server and a second data source from an interactive voice response server, and for responding to requests from the interactive voice response server.

22. The telephone call routing system of claim 1, wherein the coordinator comprises a database server for storage of data corresponding to the caller, mobile resource and system operation.

23. The telephone call routing system of claim 1 wherein the caller has at least one preferred mobile resource such that the coordinator routes the telephone call to a mobile telephone located in a preferred mobile resource near the caller.

24. The telephone call routing system of claim 23, wherein each mobile resource has secondary mobile resources, which are preferred by the mobile resource, such that if the preferred mobile resource is unavailable, the coordinator routes the telephone call to a secondary mobile resource nearby with respect to the caller.

25. A method for routing a telephone call from a caller to one or more mobile resources, comprising, in combination, the steps of:
determining the location of the caller;
determining the location of at least one mobile resource; and
routing the telephone call from the caller to the mobile resource conveniently proximate the caller.

26. The method of claim 25, wherein the step of determining the location of at least one mobile resources comprises:
receiving an update transmitted from the mobile resource, at a time interval, of a current time, the location, a speed and a heading of the mobile resource; and
extrapolating a predicted location for the mobile resource between updates, by considering the location, speed and heading of the mobile resource at the previous update and the time elapsed since the last update.

27. The method of claim 26, wherein the at least one mobile resource transmits the update only when the location of the mobile resource is outside an uncertainty circle surrounding a predicted location of the mobile resource.

28. The method of claim 27, wherein a call centre routes the telephone call from the caller to a mobile resource nearby with respect to the caller.

29. The method of claim 28, wherein a radius of the uncertainty circle is controlled by the call centre, and is dependent on at least one of the location of the mobile resource and the time of day.

30. The method of claim 28 wherein the predicted location is calculated at both the mobile resource and at the call centre.

31. A method for selecting a mobile resource having a first known location with respect to a caller having a second known location, comprising, in combination, the steps of:
determining an uncertainty circle corresponding to the location of at least one mobile resources;
selecting a group of available mobile resources having circles of uncertainty which lie entirely within a predetermined distance from the caller; and
selecting the mobile resource having the uncertainty circle with a centre closest to the caller from the group of available mobile resources.

32. The method of claim 31, wherein a mobile resource is selected by considering a size of at least one of the uncertainty circles of the taxis in a catchment area.
